(19) United States
(12) Patent Application Publication
(10) Pub. No.: US 2011/0298915 A1
(43) Pub. Date: Dec. 8, 2011

(54) PATTERN INSPECTING APPARATUS AND PATTERN INSPECTING METHOD

(76) Inventors: Takashi Hiroi, Yokohama (JP); Takeyuki Yoshida, Hitachinaka (JP); Masaaki Nojiri, Hitachinaka (JP)

(21) Appl. No.: 13/201,810

(22) PCT Filed: Feb. 1, 2010
(86) PCT No.: PCT/JP2010/051321

§ 371 Date: Aug. 16, 2011

(30) Foreign Application Priority Data
Mar. 19, 2009 (JP) 2009-069035

(51) Int. Cl. H04N 7/18; G06K 9/00

(52) U.S. Cl. 348/80; 382/149; 348/E07.085

(57) ABSTRACT

In conventional methods, efficient analyses with respect to detected defects were not given consideration. A detected image is matched against pre-obtained partial images of a normal part and a defect part to determine a defect in the detected image. Then, the partial images and the detected image are synthesized to generate a review image in which the identifiability of the detected image is improved. Thus, the operator is able to readily make a determination with respect to the detected defect.

### TECHNICAL FIELD

The present invention relates to a technique suited for application in pattern inspection for semiconductor devices, liquid crystals, and so forth. By way of example, it is suited for application in electron beam pattern inspecting apparatuses and optical pattern inspecting apparatuses.

### BACKGROUND ART

Electron beam pattern inspecting apparatuses inspect for defects in a wafer by irradiating the wafer under inspection with an electron beam and detecting the secondary electrons that are produced. By way of example, inspection is carried out through the following procedure. An electron beam scans in synchrony with stage movement to obtain a secondary electron image of a circuit pattern on a wafer. Then, the obtained secondary electron image is compared with a reference image which is supposed to be of the same pattern as this image, and parts with significant differences are determined to be defects. If the detected defects are defect information in which the wafer is sampled by a statistically significant method, problems during wafer fabrication are analyzed through a detailed analysis of the defects or of the distribution of these defects.

Thus, semiconductor wafer inspecting apparatuses are used to extract problems with process equipment for fabricating wafers or with the process conditions thereof by detecting pattern defects in a wafer under fabrication and analyzing in detail or statistically processing the locations at which defects have occurred.

Currently, there have been proposed methods of detecting statistically significant defects at high speed through an improvement in the determination method or an improvement in the sampling method. The former, as presented in Non-Patent Document 1, utilizes the fact that there is a trade-off between S/N and image detection speed, and realizes high-speed inspection through an improvement in the defect determination method. The latter, as presented in Non-Patent Document 2, seeks to obtain necessary information at a low sampling rate by sampling stage movement coordinates.

### PRIOR ART DOCUMENTS

### Non-Patent Documents

Non-Patent Document 1: Takashi HIROI and Hirohito OKUDA, “Robust Defect Detection System Using Double Reference Image Averaging for High Throughput SEM Inspection Tool”, 2006 IEEE/SEMI Advanced Semiconductor Manufacturing Conference, 1-4244-0255-07/06, pp. 347-352
Non-Patent Document 2: Masami IKOTA, Akihiro MIURA, Munenori FUKUNISHI and Aritoshi SUGIMOTO, “In-line e-beam inspection with optimized sampling and newly developed ADC”, Process and Materials Characterization and Diagnostics in IC Manufacturing, Proceedings of SPIE Vol. 5041 (2003), pp. 50-60
Non-Patent Document 3: George Wolberg, “Image morphing: a survey”, The Visual Computer, 14:360-372, Springer-Verlag, 1998

### SUMMARY OF THE INVENTION

### Problems to be Solved by the Invention

However, these methods are insufficient in their focus on efficient analysis operations for the detected defects.

### Means for Solving the Problems

As such, the present inventors propose a technique in which, in inspecting patterns, a detected image of a pattern image obtained with respect to a unit under inspection is matched against a pre-generated partial image of a normal part or a defect part to determine a defect in the detected image, and a review image in which the identifiability of the detected image is improved based on the determination result is generated and presented to the operator. By thus improving the visibility of the review image, the efficiency of the defect analysis by the operator is also improved.

It is noted that the review image in the case above is preferably generated through image synthesis of a detected image and a partial image of a normal part or defect part corresponding to the detected image, or through image morphing in which a morphing method is applied to a detected image and a partial image of a normal part or defect part corresponding to the detected image, or through a replacement process with a pre-obtained high image quality partial image.

In addition, the partial image of the normal part or defect part is preferably created from the detected image. By generating it based on an actually obtained image, it is possible to generate a review image that is natural with respect to the actually obtained image.

In addition, the present inventors propose a technique in which, in inspecting patterns, a detected image of a pattern image obtained with respect to a unit under inspection is compared with a pre-obtained reference image to determine a defect in the detected image, and a review image in which the identifiability of the detected image is improved based on the determination result is generated and presented to the operator. It is noted that the review image in the case above is preferably generated through image synthesis of a defect image and the reference image, or through image morphing by applying a morphing method to the defect image and the reference image, or by optimizing the frequency components of the detected image, or by executing image processing wherein shading is eliminated from the detected image. In this case, too, the visibility of the review image is improved, and the efficiency of the defect analysis by the operator is also improved.

In addition, the present inventors propose a technique in which, in inspecting patterns, a detected image of a pattern image obtained with respect to a unit under inspection is compared with a pre-obtained reference image to determine a defect in the detected image, and a review image in which the identifiability of the detected image is improved based on the determination result is generated, while at the same time a review screen is presented to the operator, the review screen including a toggle button for selectively displaying all or part of the review image, the detected image and the reference image on the same screen as an image of a defect detected from the unit under inspection. By virtue of the fact that it is possible to toggle between views of the review screen, the efficiency of the defect analysis by the operator may also be improved.

### Effects of the Invention

By employing the techniques proposed by the present inventors, the operator is able to efficiently analyze defects detected by a pattern inspecting apparatus.

### BRIEF DESCRIPTION OF THE DRAWINGS

FIG. 1 is a diagram showing an overall configuration example of a semiconductor wafer inspecting apparatus.

FIG. 2 is a diagram illustrating a surface structure example of a semiconductor wafer to be inspected.

FIG. 3A is a diagram showing a recipe creation procedure example.

FIG. 3B is a diagram showing an inspection procedure example.

FIG. 4 is a diagram showing an example of a configuration screen for trial inspection.

FIG. 5A, FIG. 5B, FIG. 5C and FIG. 5D are diagrams generally illustrating image examples to be used in a defect monitoring operation, and a processing operation.

FIG. 6 is a diagram illustrating an example of a model generation operation by partial image extraction.

FIG. 7 is a chart showing a distribution example of normal part vectors and defect part vectors with respect to an N-dimensional space.

FIG. 8 is a diagram illustrating an embodiment of a model matching operation (Embodiment 1).

FIG. 9 is a diagram illustrating another embodiment of a model matching operation (Embodiment 2).

FIG. 10A and FIG. 10B are diagrams illustrating another embodiment of a model matching operation (Embodiment 4).

FIG. 11 is a diagram illustrating another embodiment of a model matching operation (Embodiment 5).

FIG. 12 is a diagram illustrating another embodiment of a model matching operation (Embodiment 6).

FIG. 13 is a diagram showing another configuration screen example for use in trial inspection (Embodiment 7).

### MODES FOR CARRYING OUT THE INVENTION

Embodiments of a pattern inspecting apparatus and inspecting method are described in detail below based on the drawings.

### (1) Embodiment 1

### (1-1) Overall Configuration

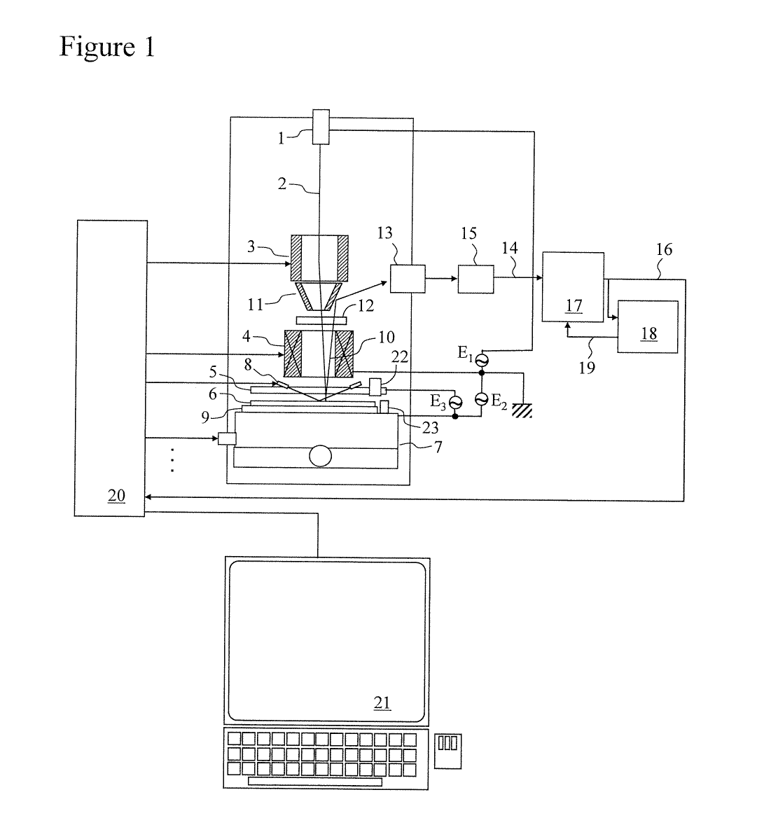

An overall configuration example of a circuit pattern inspecting apparatus according to an embodiment is shown in FIG. 1. The circuit pattern inspecting apparatus comprises an electron source 1, a deflector 3, an objective lens 4, a charge control electrode 5, an XY stage 7, a Z sensor 8, a sample stage 9, a reflector 11, a focusing optical system 12, a sensor 13, an A/D (Analog to Digital) converter 15, a defect determination part 17, a model DB (database) part 18, an overall control part 20, a console 21, an optical microscope 22, and a standard sample piece 23.

The deflector 3 is a device that deflects electrons 2 emitted from the electron source 1. The objective lens 4 is a device that focuses the electrons 2. The charge control electrode 5 is a device that controls the electric field strength. The XY stage 7 is a device that causes a semiconductor wafer 6 including a circuit pattern to move in the XY directions. The Z sensor 8 is a device that measures the height of the semiconductor wafer 6. The sample stage 9 is a device that holds the semiconductor wafer 6. The reflector 11 is a device which, upon receiving secondary electrons or reflected electrons 10, produces secondary electrons again. The focusing optical system 12 is a device that focuses onto the reflector 11 the secondary electrons or reflected electrons 10 that are produced as a result of irradiation by the electrons 2. The sensor 13 is a device that detects secondary electrons by way of the reflector. The A/D (Analog to Digital) converter 15 is a device that converts a signal detected at the sensor 13 into a digital signal 14. The defect determination part 17 is a device that extracts defect information 16 by performing image processing on the digital signal 14. The model DB (database) part 18 is an apparatus that registers the defect information 16 obtained from the defect determination part 17 as model information 19. The overall control part 20 is a device having a function of receiving the defect information 16 obtained from the defect determination part 17 and a function of exercising overall control. The console 21 is a device that communicates the instructions of the operator to the overall control part 20 while at the same time displaying information on defects and models. The optical microscope 22 is a device that captures an optical image of the semiconductor wafer 6. The standard sample piece 23 is a device for making fine adjustments to the electron optical conditions configured to the same height as the wafer 6 to be inspected.

It is noted that, in FIG. 1, only a portion of the control signal lines outputted from the overall control part 20 is shown, and that the other control signal lines are omitted. This is to prevent the diagram from becoming complicated. Naturally, the overall control part 20 is capable of controlling all parts of the inspecting apparatus via control signal lines that are not shown in the diagram. In addition, with respect to an ExB for bending the secondary electrons or reflected electrons 10 by altering the paths of the electrons 2 produced at the electron source 1 and of the secondary electrons or reflected electrons 10 produced at the wafer 6 under inspection, a wafer cassette for storing the semiconductor wafer 6, and a loader for loading/unloading the wafer in the cassette, illustrations and descriptions have been omitted in FIG. 1 in order to prevent the diagram from becoming complicated.

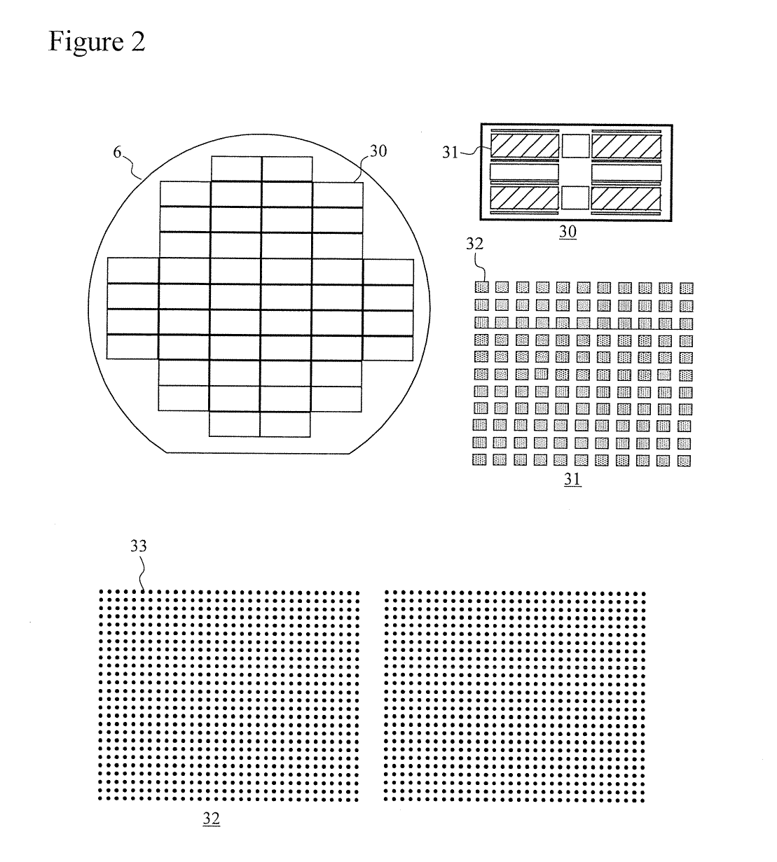

A plan view of the semiconductor wafer 6 under inspection in this embodiment is shown in FIG. 2. The semiconductor wafer 6 is in the shape of a disc that is approximately 200 to 300 mm in diameter and 1 mm in thickness, and circuit patterns for several hundred to several thousand products are simultaneously formed on its surface. The circuit patterns comprise rectangular circuit patterns called dies 30 each corresponding to one product. The pattern layout of the die 30 of a common memory device comprises four memory mat groups 31. The memory mat groups 31 each comprise approximately 100×100 memory mats 32. The memory mats 32 each comprise several million two-dimensionally repetitive memory cells 33.

### (1-2) Inspection Operation

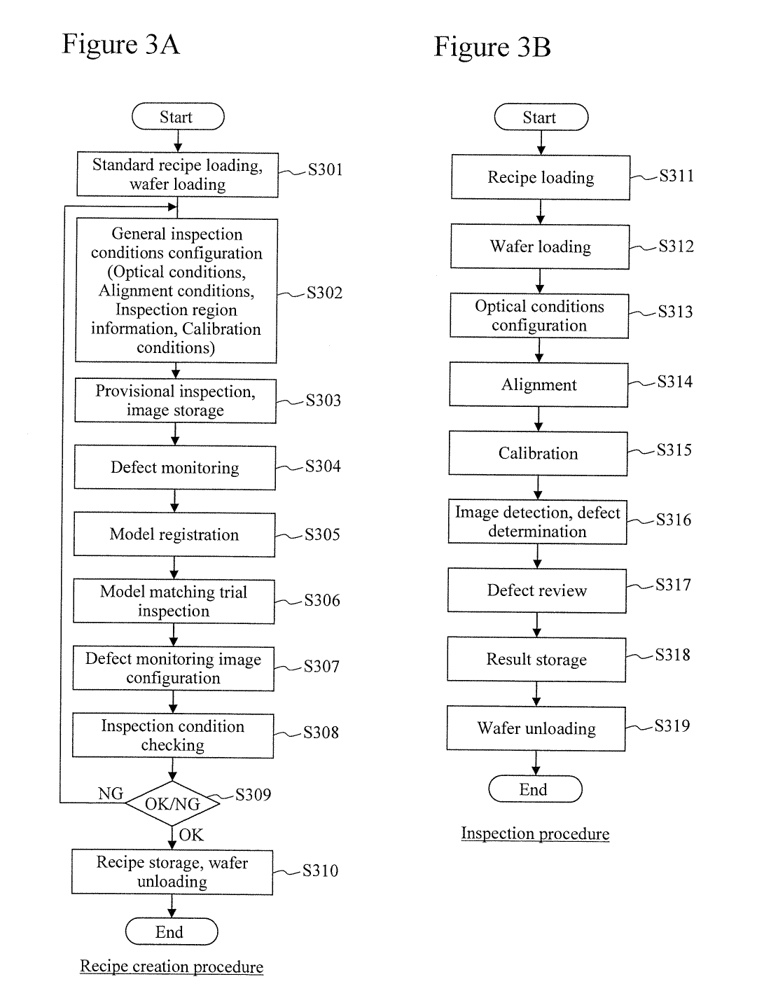

Prior to inspection, recipe creation for determining the inspection procedure and inspection method is performed, and inspection is performed in accordance with the recipe created. In this case, a recipe creation procedure is described using FIG. 3A. As the operator issues a command via the console 21, a standard recipe is loaded into the overall control part 20, the semiconductor wafer 6 is loaded from the cassette (not shown) by means of the loader (not shown) and mounted on the sample stage 9 (step 301).

Next, various conditions of the electron source 1, the deflector 3, the objective lens 4, the charge control electrode 5, the reflector 11, the focusing optical system 12, the sensor 13, and the AD converter 15 are configured (step 302). Then, an image of the standard sample piece 23 is detected, and corrections are made to configuration values configured for the respective parts to bring them to appropriate values. Next, with respect to the pattern layout of the semiconductor wafer 6, layouts of the memory mats 32 are specified in rectangles as regions in which memory cells 33 are repeated, and memory mat groups 31 are defined as rectangular repetitions of the memory mats 32.

Next, a pattern for alignment and coordinates thereof are registered, and alignment conditions are configured. Next, inspection region information to be inspected is registered. The detected amount of light varies from wafer to wafer. In order to perform inspection under uniform conditions, a coordinate point for obtaining an image suited for calibrating the amount of light is selected, and initial gain and a calibration coordinate point are defined. Next, with the console 21, the operator selects an inspection region, pixel dimensions, and the number of times addition is to be performed, and configures the conditions in the overall control part 20.

Once the configuring of these general inspection conditions has been completed, the overall control part 20 stores the detected image in the memory within the defect determination part 17 (step 303).

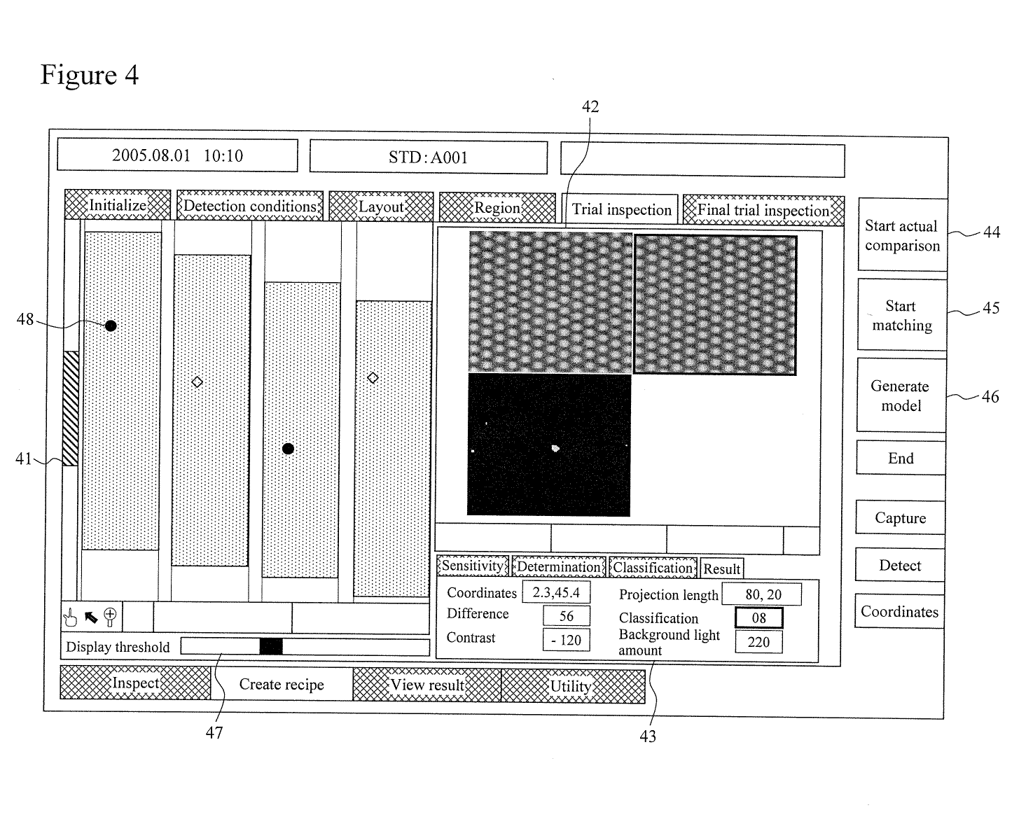

Next, an operation screen (GUI) example displayed on the console 21 is shown in FIG. 4. Using the GUI shown in FIG. 4, the operator configures conditions for executing model matching with respect to a stored image. The GUI shown in FIG. 4 comprises a map display part 41, an image display part 42, a defect information display part 43, a start actual comparison button 44, a start matching button 45, a generate model button 46, and a defect display threshold adjustment tool bar 47. It is noted that the map display part 41 is a region that displays a stored image. The image display part 42 is a region that displays a detected image when clicked on in the map display part 41 or a defect image when a defect displayed in the map display part 41 is clicked on. The defect information display part 43 is a region that displays defect information of a defect displayed in the image display part 42.

As the operator sets an appropriate threshold through the defect display threshold adjustment tool bar 47 and clicks on the start actual comparison button 44, the overall control part 20 executes a comparison between actual patterns based on images that have been stored in advance. In other words, a provisional inspection for performing a defect determination is executed. The console 21 displays in the map display part 41 a defect 48 having a difference that is equal to or greater than the threshold. The operator clicks on the defect 48 displayed in the map display part 41 to cause the image and information for the defect to be displayed in the image display part 42 and the defect information display part 43, respectively.

Then, the operator classifies the stored image as a normal part or a defect based on the displayed information, thereby correcting the classification in the defect information display part 43 (step 304). It is noted that the display field for classification is shown enclosed with bold lines in FIG. 4. In the case of FIG. 4, the classification symbol “08” is entered. Once the classification of representative defects is finished, the operator specifies in the defect information display part 43 the classification number of the DOI (Defect of Interest) for which model generation is desired, and clicks on the generate model button 46. Then, the overall control part 20 instructs the model DB part 18 to generate a model with respect to the specified classification number. At the model DB part 18, the model information 19 is generated by statistically processing images of a normal part and the DOI and is stored inside the model DB part 18 (step 305).

Next, as the operator clicks on the start matching button 45, a model matching trial inspection is executed (step 306). In a model matching trial inspection, the model information 19 is forwarded from the model DB part 18 to the defect determination part 17 prior to inspection. At the defect determination part 17, the inputted image is matched against the model information 19, and the defect information 16, to which information to the effect that it is closest or that none match at all is added as a classification result, is computed. The computed result is outputted to the overall control part 20. Thus, it is possible to determine that the defect that was defined as being a normal part matches the model, and it is possible to determine that the other defects do not match the model.

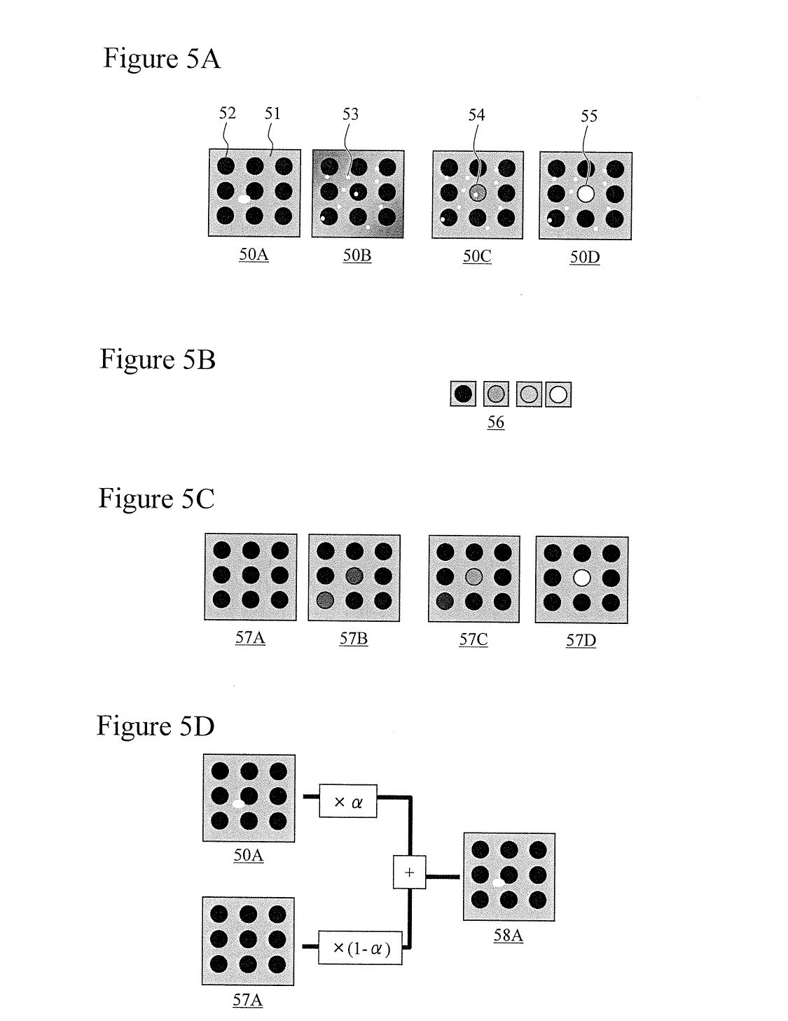

Next, an operation for configuring a defect monitoring image (step 307) is described using FIGS. 5A through 5D. FIGS. 5A through 5D are examples of images that may be displayed on the operation screen (GUI) shown in FIG. 4. Examples of typical detected images are shown in FIG. 5A. In typical detected images 50A and 50B of normal parts, there is a black hole pattern 52 on a background pattern 51, and at the same time there is noise 53. On the other hand, in detected images 50C and 50D of defect parts, as additions to the detected images 50A and 50B of normal parts, there are a gray hole pattern 54 and a white hole pattern 55 of light intensities that differ from those of normal parts.

In configuring a defect monitoring screen, model images 56 of normal parts and DOI defects are generated based on the detected images 50A through 50D. An example of a case in which four model images 56 are generated is shown in FIG. 5B. FIG. 5C shows synthesized model images 57A through 57D generated by synthesizing the detected images 50A through 50D with the model images 56. Thus, all images of the synthesized model images 57A through 57D may be given through a combination of the typical model images 56. However, only partial information of the detected images 50A through 50D before synthesis is included in the synthesized model images 57A through 57D.

Thus, in configuring a defect monitoring screen, the detected images 50A through 50D and the synthesized model images 57A through 57D are synthesized based on blending proportion a defined by the operator for each classification type, thereby generating a defect monitoring image 58A. This process is visually represented in FIG. 5D.

Then, the operator checks the inspection conditions including classification information (step 308). If there is no problem with this check (if step 309 is OK), the operator instructs the termination of recipe creation. On the other hand, if there is a problem (if step 309 is NG), execution of the aforementioned process from step 302 to step 308 is repeated. It is noted that, if termination of recipe creation is instructed, the wafer is unloaded and recipe information including the model information 19 within the model DB part 18 is stored (step 310).

Next, the content of the process executed at the time of actual inspection is described using FIG. 3B. The actual inspection operation is started by specifying a wafer to be inspected and recipe information (step 311). As a result of this specification, a wafer is loaded to an inspection region (step 312). In addition, optical conditions for the respective parts, such as the electron optical system, etc., are configured (step 313). Then, preliminary operations are executed through alignment and calibration (steps 314 and 315).

An image of the configured region is thereafter obtained and matched against model information (step 316). This matching process is executed by the overall control part 20. It is noted that, in the matching process, a region that is determined to match with defect model information or an image that is determined to match with none of the models is determined as being a defect.

Once defect determination is finished, defect review is executed (step 317). This review is executed through a display of a review screen on the console 21. The detected image 50 obtained during inspection, or a re-obtained image obtained by moving the stage again to the defect coordinates, or the synthesized model image 57, or the defect monitoring image 58 is displayed on the review screen, and a checking operation by the operator with respect to defect type is executed based on the displayed image. Once the review is completed, the necessity of a quality determination, or an additional analysis, of the wafer is determined based on the defect distribution per defect type. Then, the storing of the result and the unloading of the wafer are executed, and the inspection process for the wafer is terminated (steps 318 and 319).

### (1-3) Details of Model Registration Operation and Matching Operation

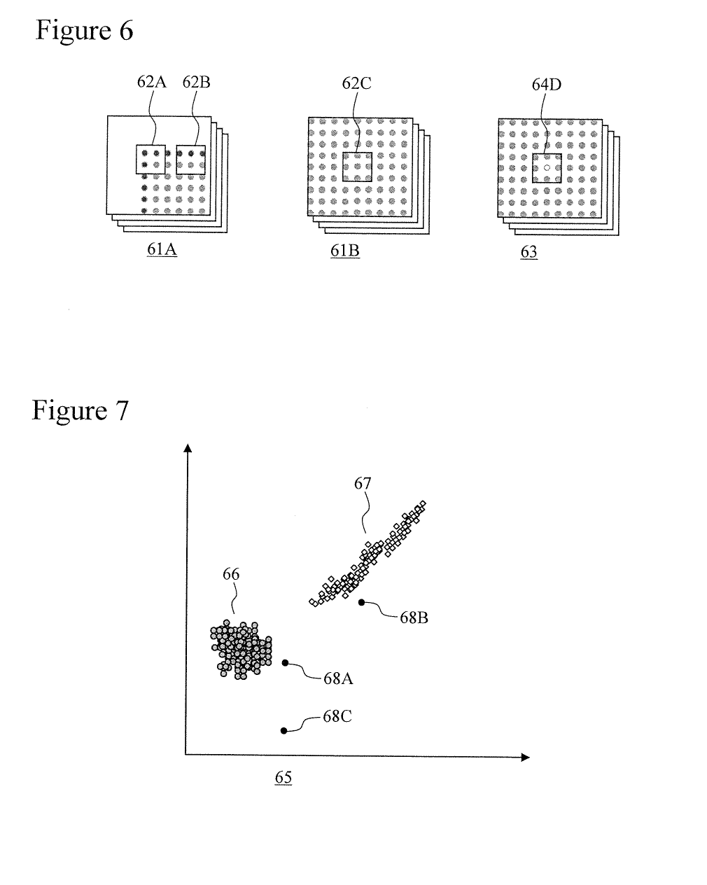

Lastly, detailed operations executed at the defect determination part 17 and the model DB part 20 are described using FIG. 6 and FIG. 7. First, the model generation process is described using FIG. 6. The model generation process is executed in step 305.

First, as shown in FIG. 6, partial images 62A, 62B and 62C of 7×7 pixels are extracted from images 61A and 61B of normal parts. In addition, a partial image 64D is extracted from an image 63 of one type of defect (DOI). The 7×7-pixel image is deemed a vector with 49 elements, and a normal part and one type of DOI defect type are canonically analyzed. As a result, as shown in FIG. 7, a normal part vector 66 and a defect part vector 67 become distinguishable with respect to a given N-dimensional space 65. At the model DB part 20, based on this distinction result, a plurality of typical images with respect to normal parts and a plurality of typical images with respect to defects are registered as model images. The typical images in this case are defined by also taking into consideration the location information (such as edge part or center part, etc.) within the memory mats 33.

Next, the matching process for a model image and a detected image is described using FIG. 7. This matching process is executed in step 306 and also in step 316. In this matching process, it is determined whether or not vectors 68A, 68B and 68C of the detected images are close to the normal part vectors 66 or the defect part vectors 67. In the case of FIG. 7, it is determined that the vector 68A is close to the normal part vectors 66. Thus, the detected image corresponding to the vector 68A is classified as a normal part. Similarly, in the case of FIG. 7, it is determined that the vector 68B is close to the defect part vectors 67. Thus, the detected image corresponding to the vector 68B is classified as a defect. In addition, as in the vector 68C, when it is determined that it belongs to neither the normal part vectors 66 nor the defect part vectors 67, it is determined that the detected image corresponding to the vector 68B does not match with the model.

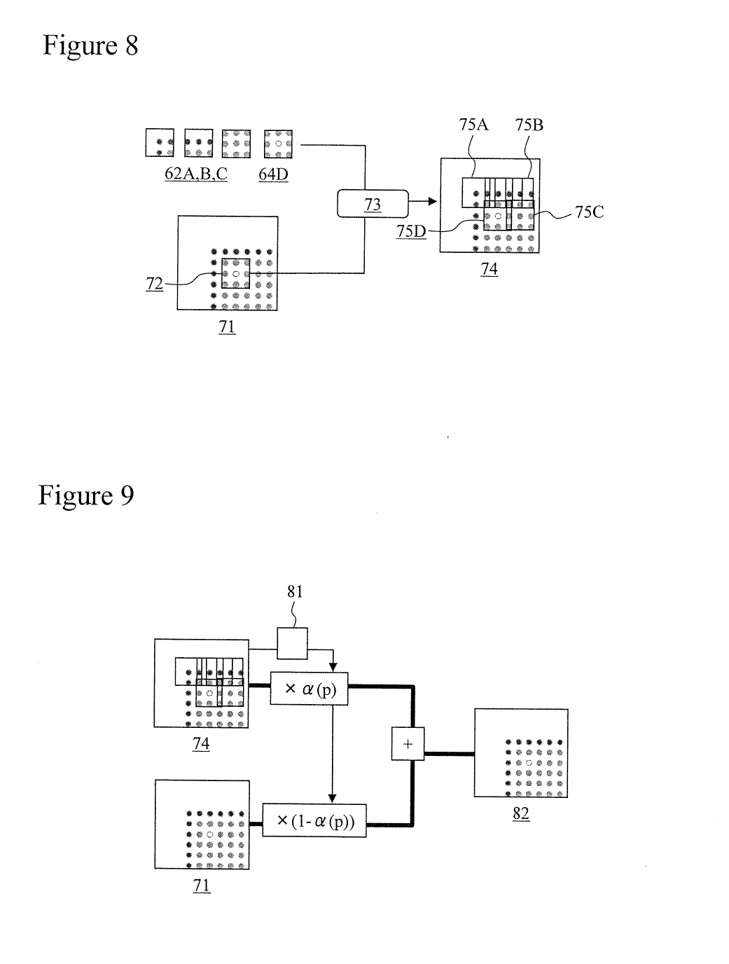

The model matching operation executed in step 306 is visually represented in FIG. 8. In this case, a cut-out image 72 of a detected image 71 and the plurality of partial images 62A, 62B, 62C and 64 are matched against one another at a matching part 73, and a matching result image 74 is computed. It is noted that the partial images 62A, 62B, 62C and 64 correspond to the synthesized model images 57A through 57D. In addition, the processing operation of the matching part 73 is executed at the defect determination part 17.

The matching result image 74 is formed by further superimposing synthesized partial images 75A through 75D in which the partial images 62A, 62B, 62C and MD, which matched with the cut-out image 72 by a predetermined threshold or greater, have been synthesized at blending proportion a defined per classification type. With respect to this matching result image 74, image parts of the detected image 71 that are determined to be normal parts have image features of typical normal parts emphasized, and images determined to be defects have image features of typical defects emphasized. Thus, with respect to the matching result image 74, the operator may readily determine normal parts and defects. Specifically, the operator may readily determine that, of the matching result image 74, the part synthesized with the partial image 64D is a defect. In addition, the matching result image 74 comprises, as attribute information of each pixel, the ID of the partial image against which it was matched and the degree of match.

It is noted that the matching operation based on this operation is also executed in a similar fashion in the defect review operation in step 317.

### (1-4) Summary

As described above, by using a processing technique according to this embodiment, it is possible to determine defects and normal parts per defect type. At the same time, it is also possible to determine defects that differ from both. In addition, the review operation for detected images may be executed with respect to the matching result image 74 that has been corrected to emphasize the various features a detected image has using model images. Thus, the operator is able to efficiently move the review operation along

### (2) Embodiment 2

A modification of Embodiment 1 is described using FIG. 9. FIG. 9 illustrates a method of generating a matching result image to be displayed on the console 21 for review. In this embodiment, there is proposed a method in which the matching result image 74 and the detected image 71 are further blended. For this blending, a conversion table 81 is used. In the conversion table 81 are stored, in association with each other, degree of match attributes corresponding to the respective pixels and corresponding blending proportions α(p) (where 0≦α(p)≦1). It is noted that the p in blending proportions α(p) stands for pixel.

Thus, in the case of Embodiment 2 shown in FIG. 9, blending proportion α(p) corresponding to the degree of match of the attribute held by each pixel p of the matching result image 74 is read from the conversion table 81, and the matching result image 74 and the detected image 71 are blended pixel by pixel at blending proportions α(p) that are read. The blend result is outputted as a review image 82. It is noted that blending proportions α(p) are so defined as to be of a higher value the higher the degree of match is.

In the case of this embodiment, it is possible to automatically define blending proportion α(p) per pixel. Thus, it is possible to accord more weight to the matching result image 74 for known defect modes and normal parts, while otherwise according more weight to the detected image 71, thereby generating a more natural review image 82.

### (3) Embodiment 3

A further modification of Embodiment 1 will now be described. In the case of Embodiment 1, a description was provided with respect to a case in which the detected image 71 and partial images (model images) were simply synthesized. However, by synthesizing images using the mesh warping method (a so-called morphing method) disclosed in Non-Patent Document 3, it is possible to realize a synthesized image better reflecting the information of the detected image 71. It is noted that the mesh warping technique (a so-called morphing method) applied here refers to a technique in which synthesis is performed in such a manner as to maintain the correspondence between respective feature points of the images subject to synthesis. By way of example, where there are differences in size and shape between the patterns of a partial image (model image) and the detected image 71, by synthesizing the images in such a manner as to maintain the correspondence between respective feature points of the two images, it is possible to generate a more accurate and natural review image.

### (4) Embodiment 4

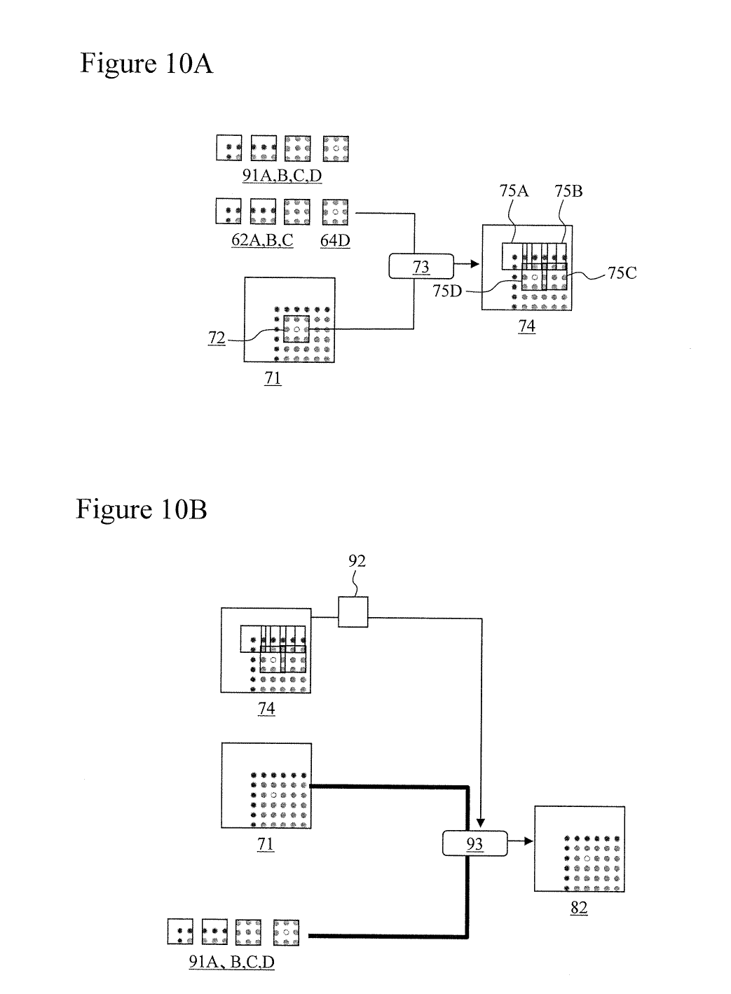

Next, a further modification of Embodiment 1 is described. In the case of this embodiment, two modes are provided as review image generation modes. Specifically, normal mode and DB (database) mode are provided. It is noted that normal mode refers to the method described in connection with Embodiment 1. With respect to the following, the operations in normal mode are shown in FIG. 10A, and the operations in DB mode in FIG. 10B.

It is noted that, in the case of this embodiment, it is assumed that, at the time of generation of the partial images 62A, 62B, 62C and 64D, which are to serve as model images, review DB images 91A through D are already obtained in a detection mode that allows for a more accurate determination of defects. It is noted that what is meant by a detection mode that allows for a more accurate determination of defects is, by way of example, a mode in which the pixel dimensions are made smaller, or in which the amount of current of the emitted electrons 2 is lowered, the resolution raised, and the number of times addition is performed increased.

In normal mode, the matching result image 74 as a review image is generated through the method shown in FIG. 10A corresponding to FIG. 8. Specifically, the matching result image 74 is formed by further superimposing the synthesized partial images 75A through 75D in which the partial images 62A, 62B, 62C and 64D, which matched with the cut-out image 72 by a predetermined threshold or greater, have been synthesized at blending proportions a defined per classification type.

On the other hand, in DB mode, as shown in FIG. 10B, the corresponding review DB images 91A through 91D are extracted based on partial image IDs that the matching result image 74 possesses as attribute information, and the review image 82 is generated by patching them together at corresponding parts. In this case, a conversion table 92 stores relationships between patching locations and partial image IDs. Thus, partial image IDs extracted from the attribute information of the matching result image 74 and patching locations corresponding thereto are given from the conversion table 92 to an image forming part 93. In addition, the image forming part 93 synthesizes the review image 82 by selecting the review DB images 91A through 91D corresponding to the partial image IDs it has been given and patching them together at respective locations.

By employing this DB mode, it is possible to use a review image in which replacements have been performed based on detailed images corresponding to the model images. Consequently, the operator is able to perform a review operation based on a review image that reflects the actual pattern state with high definition and high S/N. By virtue of the fact that it is thus possible to perform a review operation using a high-definition image, it is possible to achieve extremely high review efficiency. It is noted that the obtaining of a high-definition image is executed only with respect to pattern regions that are registered as model images. Thus, the operation time required for obtainment can be kept to a minimum.

### (5) Embodiment 5

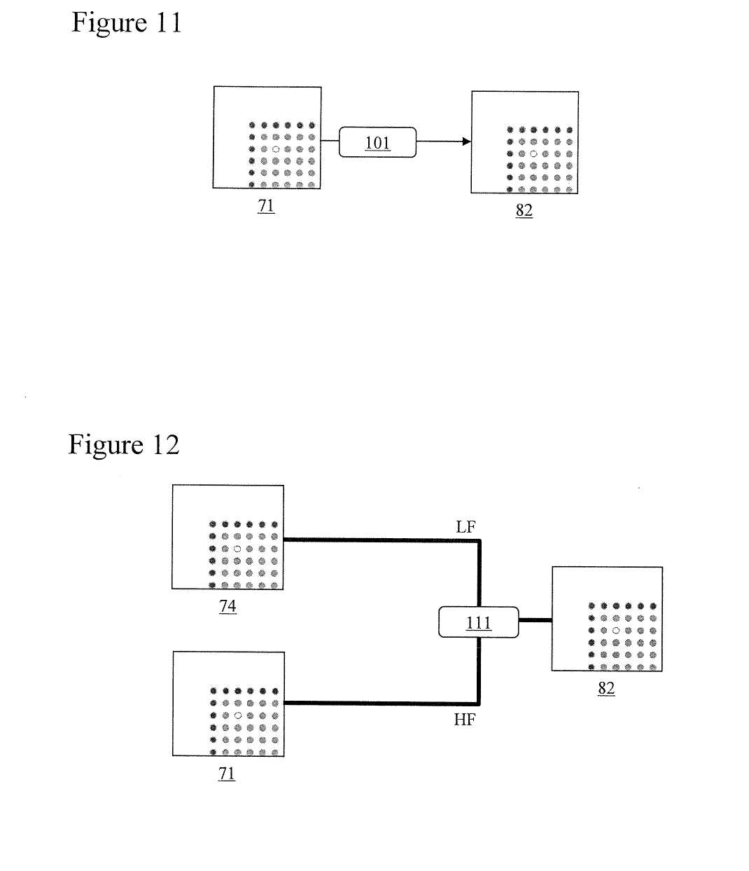

Next, a further modification of Embodiment 1 is described. The generation of the review image 82 according to this embodiment is visually represented in FIG. 11. In the case of this embodiment, there is proposed a method in which the detected image 71 is inputted to an image processing part 101, and the review image 82 is created based on the image processing functions thereof.

By way of example, the image processing part 101 is equipped with an image processing function comprising, for example, a process of extracting frequency components by an FFT (Fast Fourier Transform), a process of cutting off high-frequency components, and a process of inversely transforming the processing results. This image processing function is capable of eliminating from the detected image 71 high-frequency components that are presumably all noise components. In addition, by way of example, the image processing part 101 may also be equipped with an image processing function that eliminates particular frequency components using a digital filtering technique. This image processing function would allow for an improvement in the frequency characteristics of the detected image 71.

Thus, in the case of this embodiment, it is possible to generate a review image through extremely simple processing. Further, since the operator is able to perform a review operation based on an image with no noise or little noise, it is possible to improve review efficiency.

### (6) Embodiment 6

Next, a further modification of Embodiment 1 is described. The generation of the review image 82 according to this embodiment is visually represented in FIG. 12. In the case of this embodiment, there is proposed a method in which the detected image 71 and the matching result image 74 are inputted to an image processing part 111, and the review image 82 is generated based on the image processing functions thereof.

By way of example, the image processing part 111 is equipped with an image processing function in which a process that replaces the low-frequency components of the detected image 71 with the low-frequency components of the matching result image 74 is performed with respect to a frequency space that uses an FFT. In addition, by way of example, the image processing part 111 is equipped with an image processing function that superimposes onto the detected image 71 the difference in two-dimensional displacement average between the matching result image 74 and the detected image 71. Being equipped with these image processing functions allows for an improvement in low-frequency components, such as shading, etc.

Thus, in the case of this embodiment, it is possible to generate a review image by means of a simple image processing function. Further, since review can be performed with an image with no shading, it is possible to improve review efficiency.

### (7) Embodiment 7

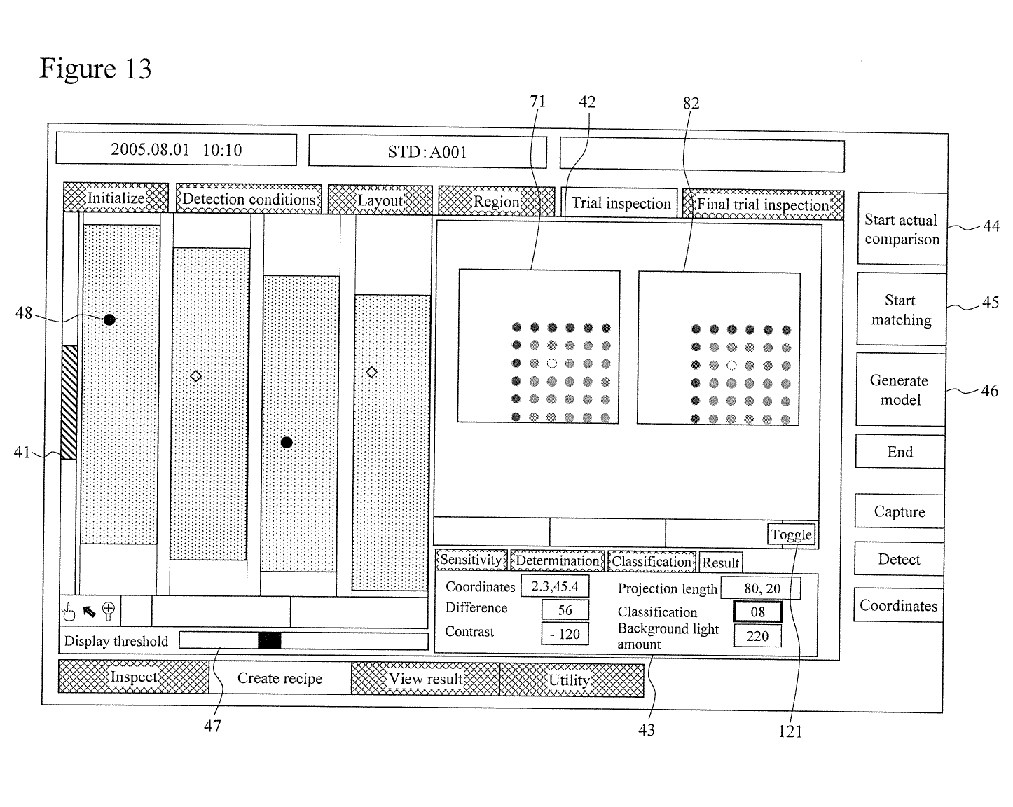

Next, a further modification of Embodiment 1 is described. A configuration example of a configuration screen for trial inspection according to this embodiment is shown in FIG. 13. It is noted that, in FIG. 13, parts that find correspondence in FIG. 4 are indicated with like reference numerals. The GUI shown in FIG. 13 comprises the map display part 41, the image display part 42, the defect information display part 43, the start actual comparison button 44, the start matching button 45, the generate model button 46, the defect display threshold adjustment tool bar 47, and a review image toggle button 121. In other words, the presence/absence of the review image toggle button 121 is where FIG. 4 and FIG. 13 differ.

The review image toggle button 121 provides a function of toggling the display modes of the image display part 42. Specifically, it is used to instruct toggling between views that are based on a screen in which two images, namely the detected image 71 and the review image 82, are displayed side by side, a screen in which three images, namely the detected image 71, the review image 82 and the matching result image 74, are displayed side by side, a screen in which only one of these three images is displayed, and a screen in which only two of these three images are displayed.

Providing this review image toggle button 121 allows the operator to perform a review operation while selectively toggling between a plurality of types of images with respect to the same pattern region. Thus, it is possible to perform a review operation using the screen that is easiest for the operator to make determinations with, or to perform a review operation through a comparison of images.

### (8) Other Embodiments

The review techniques according to the embodiments discussed above were described with respect to cases that dealt mainly with the matching result image 74. However, the review techniques discussed above may also be applied with a pre-obtained reference image substituted for the descriptions regarding the matching result image 74, as in ordinary actual pattern comparison processes. Similarly, the review techniques discussed above may also be applied with the reference image disclosed in Non-Patent Document 1 substituted for the descriptions regarding the matching result image 74. Similarly, the review techniques discussed above may also be applied with a design pattern to be used when making comparisons with design patterns substituted for the descriptions regarding the matching result image 74.

The embodiments discussed above were described with respect to cases where all functions were implemented within an electron beam pattern inspecting apparatus. However, it is also possible to equip some apparatus other than the pattern inspecting apparatus with the review image generation function or the review image display part.

The embodiments discussed above were described mainly with respect to electron beam pattern inspecting apparatuses. However, they are also applicable to optical pattern inspecting apparatuses.

### LIST OF REFERENCE NUMERALS

1 . . . electron source, 2 . . . electron, 3 . . . deflector, 4 . . . objective lens, 5 . . . charge control electrode, 6 . . . semiconductor wafer, 7 . . . XY stage, 8 . . . Z sensor, 9 . . . sample stage, 10 . . . secondary electron or reflected electron, 11 . . . reflector, 12 . . . focusing optical system, 13 . . . sensor, 14 . . . digital signal, 15 . . . A/D converter, 16 . . . defect information, 17 . . . defect determination part, 18 . . . model DB part, 20 . . . overall control part, 21 . . . console, 22 . . . optical microscope, 23 . . . standard sample piece, 30 . . . die, 31 . . . memory mat group, 32 . . . memory mat, 33 . . . memory cell, 41 . . . map display part, 42 . . . image display part, 43 . . . defect information display part, 44 . . . start actual comparison button, 45 . . . start matching button, 46 . . . generate model button, 47 . . . defect display threshold adjustment tool bar, 48 . . . defect, 50A, 50B . . . detected image of normal part, 50C, 50D . . . detected image of defect part, 51 . . . background pattern, 52 . . . black hole pattern, 53 . . . noise, 54 . . . gray hole pattern, 55 . . . white hole pattern, 56 . . . model image, 57 . . . synthesized model image, 58 . . . defect monitoring image, 61 . . . image of normal part, 62 . . . partial image of normal part, 63 . . . image of DOI, 64 . . . partial image of DOI image, 65 . . . N-dimensional space, 66 . . . normal part vector, 67 . . . defect part vector, 68 . . . detected image vector, 71 . . . detected image, 72 . . . cut-out image, 73 . . . matching part, 74 . . . matching result image, 75 . . . synthesized partial image, 81 . . . conversion table, 82 . . . review image, 91 . . . review DB image, 101 . . . image processing part, 111 . . . image processing part, 121 . . . review image toggle button

1-8. (canceled)

9. A pattern inspecting apparatus, comprising:
an image detection part that obtains an image of a pattern that a unit under inspection has;
a model database part that stores a pre-generated model image of a normal part or a defect part;
a defect determination part that matches a detected image obtained at the image detection part against the model image, and that determines a defect in the detected image based on a matching result;
an image generation part that generates an image based on a determination result of the defect determination part by synthesizing the model image with the detected image, or by replacing a portion of the detected image with the model image; and
a display part that displays the image generated through synthesis or replacement.

10. A pattern inspecting apparatus according to claim 9, wherein the image generation part generates the image to be displayed on the display part through image synthesis of the detected image with a model image of a normal part or defect part corresponding to the detected image, or through image morphing in which a morphing method is applied to the detected image and the model image of the normal part or defect part corresponding to the detected image, or through a replacement process with a pre-obtained high image quality model image.

11. A pattern inspecting apparatus according to claim 9, wherein the model image of the normal part or defect part is created from the detected image obtained at the image detection part.

12. A pattern inspecting method, comprising:
obtaining a detected image of a pattern that a unit under inspection has;
matching the detected image against an image generated from the detected image, and determining a defect in the detected image based on a matching result;
generating, based on a determination result, an image by synthesizing the image generated from the detected image with the detected image, or by replacing a portion of the detected mage with the image generated from the detected image; and
displaying the image generated through synthesis or replacement.

13. A pattern inspecting method according to claim 13, wherein the image to be displayed on the display screen is generated through image synthesis of the detected image with a model image of a normal part or defect part corresponding to the detected image, or through image morphing in which a morphing method is applied to the detected image and the model image of the normal part or defect part corresponding to the detected image, or through a replacement process with a pre-obtained high image quality model image.

14. A pattern inspecting apparatus, comprising:
an image detection part that obtains an image of a pattern that a unit under inspection has;
a defect determination part that matches an image generated from a detected image obtained at the image detection part against the detected image, and that determines a defect in the detected image based on a matching result;
an image generation part that generates an image based on a determination result of the defect determination part by synthesizing the image generated from the detected image with the detected image, or by replacing a portion of the detected image with the image generated from the detected image; and
a display part that displays the image generated through synthesis or replacement.

15. A pattern inspecting apparatus according to claim 9, wherein the model image is a reference image obtained by imaging a portion corresponding to the detected image of the unit under inspection.

16. A pattern inspecting apparatus according to claim 9, wherein the image generated through synthesis or replacement is displayed on the display part as a defect image.

17. A pattern inspecting apparatus according to claim 9 or 14, further comprising an operation part for operating a toggling of display modes of the display part, wherein
the display part is capable of selectively displaying all or part of the generated image, or the detected image, or the reference image.

18. A pattern inspecting method, comprising:
obtaining an inspection image of a pattern that a unit under inspection has;
matching the obtained detected image against pre-registered model images corresponding to a normal part and a defect part, and determining a defect in the obtained detected image based on a matching result;
generating an image based on a determination result by synthesizing the model images with the detected image, or by replacing a portion of the detected image with the model images; and
displaying the image generated through synthesis or replacement on a display image.

19. A pattern inspecting method according to claim 18, wherein the model images are reference images obtained by imaging a portion corresponding to the detected image of the unit under inspection.
